(19) United States
(12) Patent Application Publication
(10) Pub. No.: US 2015/0004579 A1
(43) Pub. Date: Jan. 1, 2015

(54) Exercise and Diet Monitoring System

(71) Applicant: Kenneth Shelton, Chico, CA (US)

(72) Inventor: Kenneth Shelton, Chico, CA (US)

(21) Appl. No.: 13/929,840

(22) Filed: Jun. 28, 2013

(51) Int. Cl. G09B 19/00; A63B 24/00

(52) U.S. Cl. CPC G09B 19/003; A63B 24/0087
USPC 434/247

(57) ABSTRACT

An exercise and diet monitoring system that includes a monitoring unit that is operable to receive, store and transmit a multitude of parameters regarding an particular diet and exercise routine of a user. The exercise and diet monitoring system further includes a monitoring unit that is configured to receive inputted data via a screen. The monitoring unit further includes a plurality of motion sensors that are operable to detect the axis of motion of the monitoring unit subsequent operable coupling to exercise equipment. The system further includes an online database and software that is operable to collect, store, manipulate and generate reports utilizing the exercise parameter data collected by the monitoring unit.

### FIELD OF THE INVENTION

The present invention relates generally to fitness and dietary monitoring of an individual, more specifically but not by way of limitation, a monitoring system that is integrated into existing and newly built exercise equipment that provides biometric monitoring of parameters and combines these data with inputted data to provide a plurality of reports to a user.

### BACKGROUND

Millions of individuals regularly participate in routine exercise and/or diet program as a way of life or as a means to accomplish a goal such as but not limited to weight loss. Improved physical fitness has been shown to lead to a reduction in occurrences of maladies such as diabetes and improvements in vascular health. Most individuals that typically engage in a regular exercise routine will utilize various types of equipment such as but not limited to weight machines, treadmills and free weights. It is common for participants to perform a variety of exercises to work a particular group of muscles or provide a cardiovascular workout for a defined period of time, as is done using a treadmill.

One problem with current exercise equipment and health monitoring systems is the lack of feedback that most equipment provides to the user. While conventional treadmills and similar equipment provide momentary data about speed, time used and estimated calories burned, once a user has completed their routine these data are not transported to another device for storage and compilation to be combined into usable reports for a user to provide longer term tracking of performance and milestones toward a particular objective. Essentially, once a user has finished with a conventional piece of exercise equipment the data being temporarily displayed to the user is not stored by the conventional piece of exercise equipment for later use and unless manually recorded by a user the data has been lost.

Another issue with current exercise equipment and other lifestyle systems in the lack of interconnectivity. Existing technology for exercise equipment does not provide the ability to track a user's progress and/or actions on multiple pieces of exercise equipment. The lack of this data provides no option for a user to more precisely measure their performance or be able to track progress towards an identified objective.

A further issue with existing exercise equipment is the inability to guide a user and provide a suggested routine based upon collected historical data. Since existing technology for exercise equipment does not have the ability to identify a user and associate data with the user, the ability to provide suggested exercise routines and/or exercises is non-existent.

Accordingly, there is a need for an exercise system that provides interconnectivity between a plurality of exercise equipment that collects numerous different parameters and assimilates the parameters to produce a variety of reports that guide a user towards a desired objective.

### SUMMARY OF THE INVENTION

It is the object of the present invention to provide an exercise and diet monitoring system that includes a transportable component that is operably coupled to a plurality of different types of exercise machines.

Another object of the present invention is to provide an exercise and diet monitoring system wherein the hardware component includes an input screen to facilitate the entry of certain parameters such as but not limited to weight amount and number of repetitions.

A further object of the present invention is to provide an exercise and diet monitoring system having a portable hardware component that further includes sensors operable to detect and subsequently record exercise repetitions.

Still another object of the present invention is to provide an exercise and diet monitoring system wherein the portable hardware unit is further connected to healthcare devices such as but not limited to weight scales.

An additional object of the present invention is to provide an exercise and diet monitoring system that further includes a central processing unit operable to store, receive, transmit and manipulate exercise and health metrics.

Yet a further object of the present invention is to provide an exercise and diet monitoring system that includes an on-line database accessible to a user wherein the on-line database is operable to generate a plurality of reports for a user.

Another object of the present invention is to provide an exercise and diet monitoring system that facilitates the monitoring of the exercise routine of the user and dietary intake wherein the exercise and diet monitoring system is operable to monitor more than one user.

A further object of the present invention is to provide an exercise and diet monitoring system that is operable to provide tracking and reports of a user's exercise routine and dietary intake wherein the system further provides to the user comparative data for similar demographics as the user.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a diagrammatic view of the transportable hardware component of the present invention; and

FIG. 2 is a diagrammatic view of a server database of the present invention; and

FIG. 3 is a flowchart illustrating the steps of an exemplary exercise having parameter recordation and report generation.

### DETAILED DESCRIPTION

Referring now to the drawings submitted herewith, wherein various elements depicted therein are not necessarily drawn to scale and wherein throughout the views and figures like elements are referenced with identical reference numerals, there is illustrated an exercise and diet monitoring system 100 constructed according to the principles of the present invention.

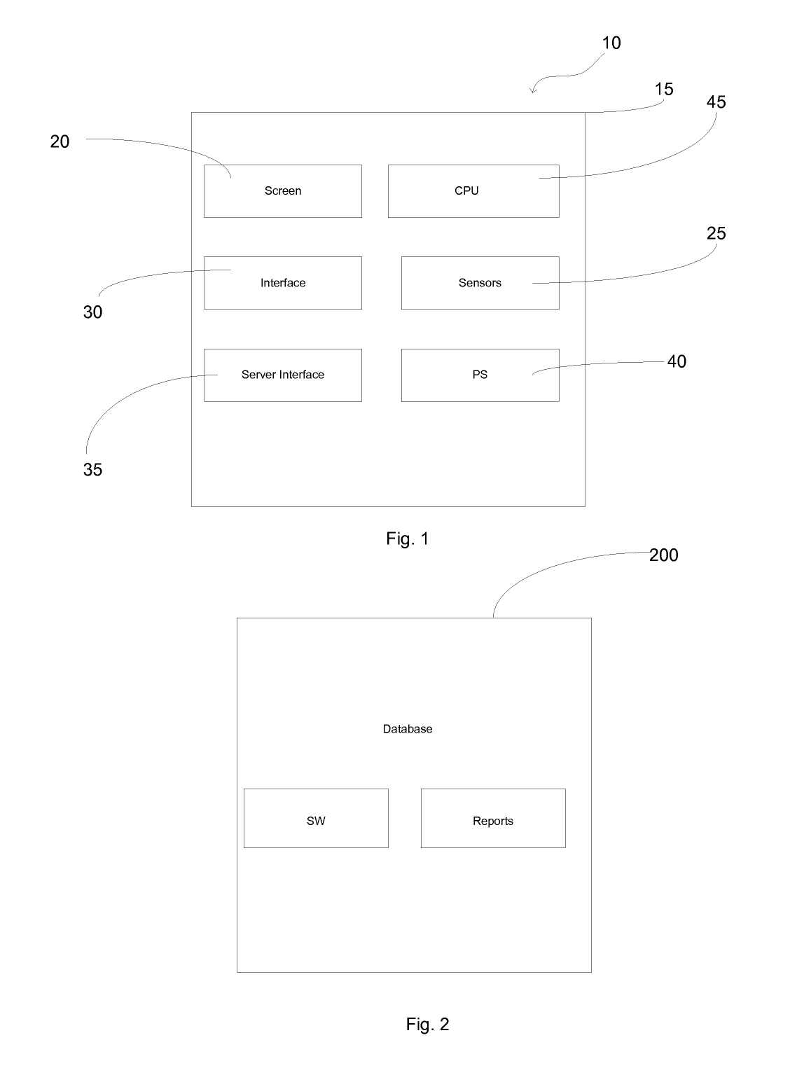

Referring in particular to FIG. 1, a diagrammatic view of the monitoring unit 10 is illustrated therein. The monitoring unit 10 includes a housing 15 that is manufactured from a suitable durable material such as but not limited to plastic. It is contemplated within the scope of the present invention that the monitoring unit 10 is ruggedly constructed to withstand the environment of a gymnasium and use therein to include but not be limited to construction techniques that provide shock resistance and water resistance. Those skilled in the art will recognize that the housing 15 could be constructed in numerous different sizes, shapes and colors so as to aesthetically appeal to a user.

The monitoring unit 10 includes a screen 20 that is a conventional LCD or similar screen that provides visual information to a user. The screen 20 is further configured as a capacitive screen system that allows a user to input various parameters upon request. It is contemplated within the scope of the present invention that the screen 20 could be constructed in numerous different sizes so as to provide ease of use for the user.

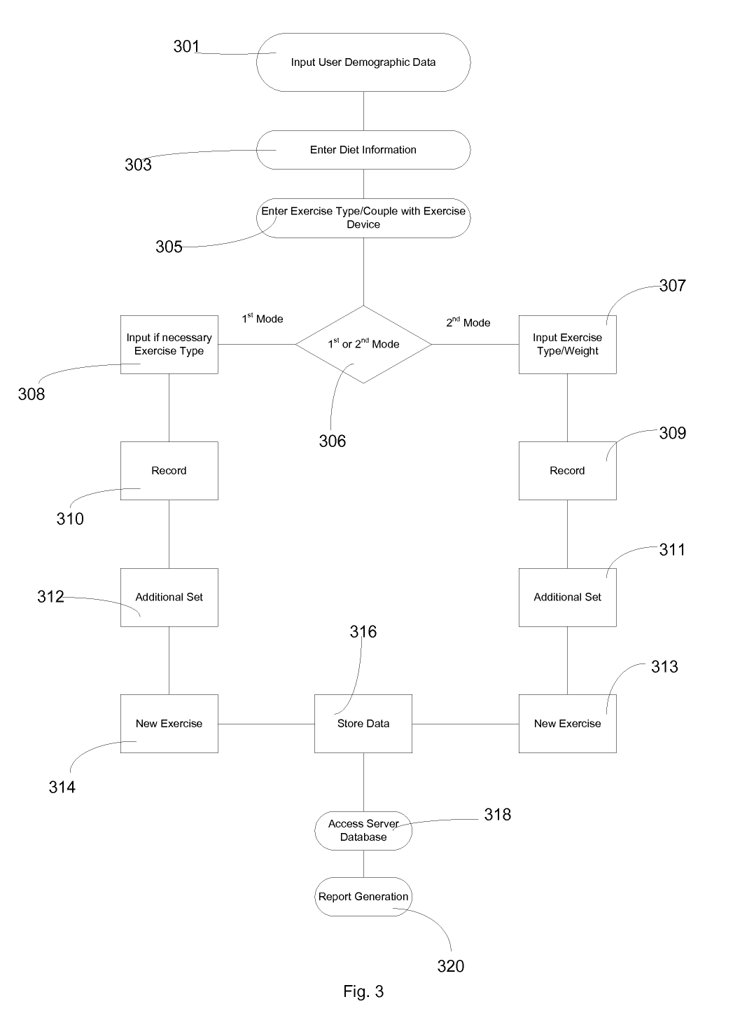

Further included in the monitoring unit are a plurality of motion sensors 25. The motion sensors 25 are operable to detect a motion such as but not limited to a bench press repetition. The monitoring unit 10 operates in a first mode and a second mode. In the first mode, the monitoring unit 10 is programmed by a user to automatically detect an activity and provide recording thereof. More specifically but not by way of limitation, if a user has programmed the monitoring unit 10 that the user is about to engage in a bench press exercise, the monitoring unit 10 will activate the motion sensors 25 so as to automatically record the quantity of repetitions performed during an exercise set. In the aforementioned first mode, the user inputs the exercise type utilizing the screen 20 and subsequently selects either automatic detection and recordation or manually enters the parameters, as further discussed herein in reference to exemplary process outlined in FIG. 3. The motion sensors 25 are disposed within the housing 15 and are operable to detect motion along an x-axis, y-axis and z-axis. The detection of motion in three axis are important as this allows the monitoring unit 10 to be operable coupled to numerous types of exercise machines and provide effective recording of the movement of the user when performing an exercise. The motion sensors 25 are conventional motion sensors using tilt switch technology configured to detect motion in an x-axis, y-axis and z-axis direction. Those skilled in the art will recognize that numerous quantities of motion sensors 25 could be disposed with the housing 15. The motion sensors 25 are operably coupled to the central processing unit 45 and provide movement data to be received, stored, manipulated and transmitted by the central processing unit 45.

The monitoring unit 10 further includes interface 30. Interface 30 is operable to communicably connect the monitoring unit 10 with exemplary exercise equipment that have compatibility therewith. Some existing exercise equipment includes operable interfaces such as but not limited to USB ports so as to communicably connect with an external device. The interface 30 is a conventional interface utilizing USB, RS-232, serial or other types of communication ports that facilitate the communicable coupling of the monitoring unit 10 with an exemplary exercise device such as but not limited to a treadmill. The interface 30 facilitates the collection of data from an exemplary exercise equipment wherein the data is received, stored and manipulated by the central processing unit 45 so as to provide a plurality of reports to a user.

The monitoring unit 10 further includes a central processing unit 45. The central processing unit 45 includes the necessary electronics to store, receive, transmit and manipulate data. The central processing unit 45 further provides functional operation of the software program intrinsic to the exercise and diet monitoring system 100. Those skilled in the art will recognize that the central processing unit 45 could include numerous quantities of memory in order to store recorded exercise parameters and inputted data.

A server interface 35 is disposed within the housing 15 of the monitoring unit 10. The server interface 35 provides an operable connection to the database 200. The server interface 35 facilitates the transfer of the recorded and inputted parameters from a user to be transferred to the database 200. While no particular type of server interface 35 is required, good results have been achieved utilizing wireless interfaces such as but not limited to Bluetooth or 802.11x. The database 200 is a conventional database stored on a server that is accessible on-line via a web portal. The database 200 includes the necessary software programs operable to generate the exemplary reports further discussed herein. Those skilled in the art will recognize that the server interface 35 could be constructed to use multiple technologies both wireless and wired in order to facilitate the operable connection between the monitoring unit 10 and the database 200.

The monitoring unit 10 further includes a power supply 40. The power supply 40 is a conventional rechargeable power supply such as but not limited to a lithium ion battery and is operable to provide the necessary power to the monitoring unit. A rechargeable power source is desirable within the scope of the present invention so as to enhance the portability of the monitoring unit 10 as a user transports the monitoring unit 10 between different pieces of exercise equipment in a gym.

Referring in particular to FIG. 3, an exemplary exercise routine is illustrated therein wherein the exercise routine incorporates the exercise and diet monitoring system 100. In step 301, the user will input their demographic data into the monitoring unit 10. The demographic data will include parameters such as but not limited to age, weight and gym membership number. Subsequent the entering of demographic data, the user will be prompted to enter general dietary information in step 303. It is contemplated within the scope of the present invention that the dietary information entered could range in specificity. By way of example of not limitation, the dietary information entered could range from general eating habits grouped in categories such as vegetarian or omnivorous to specific food types and amounts. The demographic data and dietary information are stored within the central processing unit 45 for subsequent transfer to the database 200. Alternatively, it is contemplated within the scope of the present invention that the user could perform steps 301 and 303 being directly connected to the database 200. In this embodiment the user would access the database 200 via a conventional computing device having web access and enter the aforementioned demographic and dietary information wherein these data are stored in the database 200. It is contemplated within the scope of the present invention that the dietary information could be routinely changed based on the dietary requirements and/or changes of the user.

In step 305 the user will operably couple the monitoring unit 10 to an exemplary exercise equipment. The operable coupling is facilitated by the interface 30 as previously discussed herein. In step 306, the user will program the monitoring unit 10 to operate in the first mode or in a second mode. If the first mode is selected the user will proceed to step 308. In step 308 the user will utilize the screen 25 on the monitoring unit 10 to input the exercise type. In the first mode the exercise and diet monitoring system can further be operably coupled to an exercise machine that electronically captures the exercise metric data wherein the monitoring unit 10 will receive via conventional data transfer the exercise data metrics during the exercise routine. Those skilled in the art will recognize that the monitoring unit 10 could have numerous different types of exercise types inputted therein. Ensuing entering of the exercise type, the first mode will utilize the sensors 25 to monitor for the movement of the monitoring unit 10 as previously discussed herein. The movements are detected and transmitted to the central processing unit 45 for storage of the data in step 310. In step 312, the user will engage in at least one additional exercise. During step 312 the monitoring unit 10 will receive inputted data regarding the type of exercise and then subsequently utilize the motion sensors 25 to detect the movement thereof. The exercise movement data is recorded by the central processing unit 45 and subsequently transferred to the server database 200 wherein the data is compiled for at least one report.

In step 314, the user will proceed to an additional exercise and repeat a similar process as steps 308, 310, wherein the user will enter the exercise type and the motion sensors 25 will be activated so as to record subsequent movements of the monitoring unit 10. These movement data are recorded by the central processing unit 45 and subsequently transmitted to the server database 200 for storage and to be included in report generation.

Step 316 represents storage of the exercise data from the aforementioned steps wherein the storage of the data occurs on the server database 200.

Referring back to step 306, during this step a user may select to place the monitoring unit 10 in a second mode. Selecting the second mode the user will engage in step 307. In step 307 the user will enter data pertinent to the exercise in which they are about to engage. As previously described herein the second mode requires the user to manually input data regarding the type of exercise as well as the quantity of exercise being performed. By way of example but not by way of limitation, if a user is performing a bench press exercise the user will enter the exercise type, the number repetitions to be performed, the quantity of sets to be performed and the amount of weight utilized on each set. In the second mode the user can utilize the exercise and diet monitoring system 100 when utilizing free weights to capture the desired metrics for exercise routines that where free weights such as but not limited to dumbbells are used. These data are entered via the screen 25 and are received by the central processing unit 45 wherein subsequent being stored in the central processing unit 45 are then transferred to the server database 200 to be utilized in reports. This portion of the method is graphically represented by step 309.

In step 311, the user will engage in an additional set of exercises that was previously selected and input in step 307. It is contemplated within the scope of the present invention that user could engage in numerous different quantities of sets of the same exercise wherein the data would be inputted and recorded as described herein. In step 313, the user will engage in at least one additional exercise type and enter the aforementioned data regarding the exercise type such as but not limited to number of repetitions to be performed, quantity of sets and amount of weight. As each repetition set is completed the monitoring unit 10 will store the data in the central processing unit 45 to be subsequently transferred to the server database 200.

Step 316 represents the storage of the data collected by the monitoring unit 10 in either the first mode or the second mode. The storage of the data in step 316 occurs in the server database 200. The server database 200 is a conventional online server that is operably coupled to the internet and can be accessed by the user via a conventional computing device. A operating software program is additionally stored on the server database 200 that functions to provide a graphical interface for a user to access the data stored on the server database 200 and generate reports therewith. Those skilled in the art will recognize that the server database 200 could be numerous different types of databases such as but not limited to a relational database.

In step 320, the user will engage the server database 200 to generate a plurality of different styles of reports. It is contemplated within the scope of the present invention that numerous different types of reports could be generated for the user. For example but not by way of limitation, the reports could include: exercise details and progress, biometric reporting measured during exercise, comparative reports for a demographic similar to the user, timeline progress towards a desired objective, activity summary, dietary reporting, and objective goal reports for a particular exercise. These reports are generated from the stored data on the server database 200 and are generated to the user on demand and produced in a file format such as but not limited to .pdf file wherein the file can be downloaded to numerous styles of computing devices for subsequent use.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A method of facilitating the monitoring of at least one exercise wherein exercise data is recorded for subsequent use comprising the steps of:
acquiring a monitoring unit, wherein said monitoring unit is designed to be operably coupled to a plurality of exercise equipment;
entering demographic data into said monitoring unit, wherein said entering demographic data into said monitoring unit includes the inputting of at least gender and age into said monitoring unit;
selecting from a first mode or a second mode for said monitoring unit;
coupling the monitoring unit to an exercise device;
initiating an exercise routine on the exercise device;
recording parameters of the exercise routine;
storing the parameters of the exercise routine on said monitoring unit;
transferring the parameters to a database;
accessing the database;
generating at least one report, wherein said report includes the parameters of the exercise routine.

2. The method as recited in claim 1, wherein said first mode of said monitoring unit is operable to automatically detect and record movements of a user.

3. The method as recited in claim 2, wherein in said second mode of said monitoring unit a user will manually input the parameters of the exercise routine into said monitoring unit.

4. The method as recited in claim 3, and further including the step of entering dietary information for a user into said monitoring unit.

5. The method as recited in claim 4, and further including the step of entering membership data, wherein the membership data identifies a user belonging to a particular gym.

6. The method as recited in claim 5, wherein said monitoring unit further includes a plurality of motion sensors, said plurality of motion sensors operable to detect movement of the monitoring unit in an x-axis, y-axis and z-axis direction.

7. The method as recited in claim 6, and further including the step of entering the amount of weight utilized during the exercise routine.

8. A method of facilitating the monitoring of plurality of exercises wherein the exercise data is recorded for subsequent use and wherein the method comprises the steps of:
acquiring a monitoring unit, wherein said monitoring unit is designed to be operably coupled to a plurality of exercise equipment;
entering demographic data into said monitoring unit, wherein said entering demographic data into said monitoring unit includes the inputting of at least gender and age into said monitoring unit;
selecting from a first mode or a second mode for said monitoring unit;
coupling the monitoring unit to an exercise device;
entering the exercise type to be performed on the exercise device, wherein the exercise type is entered into the monitoring unit;
initiating an exercise routine on the exercise device;
recording parameters of the exercise routine, wherein the monitoring unit records the parameters of the exercise routine;
storing the parameters of the exercise routine on said monitoring unit;
transferring the parameters to a database;
selecting at least one additional exercise routine;
entering the exercise type for said at least one additional exercise routine, wherein the exercise type is entered into the monitoring unit;
accessing the database, wherein the database in an online server database;
generating at least one report, wherein said report includes the parameters of the exercise routine.

9. The method as recited in claim 8, and further including the step of entering the amount of weight utilized in the exercise routine.

10. The method as recited in claim 9, and further including the step of entering dietary information for the user.

11. The method as recited in claim 10, wherein in said first mode said monitoring unit provide automated monitoring of the movements of a user.

12. The method as recited in claim 11, wherein in said second mode, the user will enter the parameters of the exercise routine into said monitoring unit prior to initiating the exercise routine.

13. The method as recited in claim 12, wherein said monitoring unit further includes a plurality of motion sensors, said plurality of motion sensors operable to detect movement of the monitoring unit in an x-axis, y-axis and z-axis direction.

14. The method as recited in claim 13, and further including the step of selecting a report, said selecting a report facilitated via said database wherein said step of selecting a report includes selecting a report from a provided list of report types.

15. A method of facilitating the monitoring of plurality of exercises wherein the exercise data is recorded for subsequent use and wherein the method comprises the steps of:
acquiring a monitoring unit, wherein said monitoring unit is designed to be operably coupled to a plurality of exercise equipment, said monitoring unit having a plurality of motion sensors disposed therein, said monitoring unit further including a screen;
entering demographic data into said monitoring unit, wherein said entering demographic data into said monitoring unit includes the inputting of at least gender and age into said monitoring unit;
presenting a first mode option or a second mode option to a user;
selecting the first mode option;
coupling the monitoring unit to an exercise device;
entering the exercise type to be performed on the exercise device, wherein the exercise type is entered by a user into the monitoring unit via the input screen;
initiating an exercise routine on the exercise device;
recording parameters of the exercise routine, wherein said plurality of motion sensors records the movement of the monitoring unit during the exercise routine and records metrics thereof;
storing the parameters of the exercise routine on said monitoring unit;
selecting at least one additional exercise routine;
entering the exercise type for said at least one additional exercise routine, wherein the exercise type is entered into the monitoring unit;
connecting the monitoring unit to the internet;
accessing a database, wherein the database is an online database;
transferring the parameters recorded in the exercise routine to the database;
selecting a report type;
generating at least one report, wherein said report includes the parameters of the exercise routine.

16. The method as recited in claim 15, wherein in said first mode said monitoring unit provides automated monitoring of the movements of a user.

17. The method as recited in claim 16, wherein in said second mode, the user will enter the parameters of the exercise routine into said monitoring unit prior to initiating the exercise routine.

18. The method as recited in claim 17, wherein said monitoring unit further includes a plurality of motion sensors, said plurality of motion sensors operable to detect movement of the monitoring unit in an x-axis, y-axis and z-axis direction.

19. The method as recited in claim 18, and further including the step of entering dietary information for the user.

20. The method as recited in claim 19, and further including the step of entering the amount of weight utilized in the exercise routine.
